(19) United States
(12) Patent Application Publication
(10) Pub. No.: US 2021/0231449 A1
(43) Pub. Date: Jul. 29, 2021

(54) Deep User Modeling by Behavior

(71) Applicant: Bayerische Motoren Werke Aktiengesellschaft, Muenchen (DE)

(72) Inventors: Wangsu HU, Chicago, IL (US); Jilei TIAN, Chicago, IL (US)

(21) Appl. No.: 16/750,578

(22) Filed: Jan. 23, 2020

(51) Int. Cl. G01C 21/34; G06K 9/00; G06N 3/04; G06F 17/16

(52) U.S. Cl. CPC G01C 21/3484; G01C 21/3407; G06F 17/16; G06N 3/0445; G06K 9/00335

(57) ABSTRACT

A system, method and non-transitory computer-readable medium are provided for deep user modeling of user behavior. According to the deep user modeling, user behavior vectors that represent historical user behaviors of a user are determined. Based on a concatenation of the user behavior vectors, a variable-length user behavior matrix is determined. The variable-length user behavior matrix is converted into a fixed-length embedding vector via a long short term memory network, and the fixed-length embedding vector is outputted to the user as a predicted target behavior.

### BACKGROUND AND SUMMARY OF THE INVENTION

The present invention relates to a system, method, and non-transitory computer-readable medium for modeling user behavior based on user observable behavior sequence data.

User profiling plays a central role in offering personalized service, deeper user understanding and modeling, and better service and user experience. We propose a unified algorithmic framework to deal with the user profile learning problem that aims to map the behavior objects to vectors of real numbers called “user embedding.” Such mapping is generated through in-depth machine learning to optimize the prediction task.

User profile learning can be measured from the performance of downstream tasks. For downstream tasks like ranking in a recommendation system, a good learned user profile can significantly improve prediction accuracy when predicting future user actions, since it precisely characterizes the user group to enrich the personalized recommendation.

The user profile learning also needs to be measured from the consistency between the generated embedding and empirical knowledge. The embedding aims to quantify and categorize semantic similarities between objects, how reasonable the learned embedding can characterize the objects, e.g., in semantic space, user behaviors a bit similar to their home, though their home might be in different states or countries having large geographical distance.

Effective and efficient user behavior modeling needs to be robust and semantic-rich toward the large scale dynamic dataset. It is still a challenge for both research and production. The downstream performance should be retained and learned, and embedding should be still comparable after distributing the model training.

In the present invention, we propose a unified algorithmic framework for user modeling from user behavior sequence data. With proper modeling performance measurement, it can offer significant benefits including improved personal and contextual user experience, better user segmentation and analytics, and better understanding of a user base, to improve the product, service, user engagement, promotions to users, and the like.

Traditional ways to represent a user behavior are to extract all kinds of hand-crafted features aggregated over different types of user behaviors. This feature engineering procedure guided by human instinct may fail to fully represent the data itself, and it requires too much work. For example, in trip pattern prediction, two of the basic behavior objects are location and time. Location can be an aggregated categorical feature such as “residential area” or “business district” based on its land use type and then indexed to be fed into the downstream modeling. However, such aggregation may lose information that could be precisely related with the object that needs to be predicted in the downstream application. For example, an area might be a mixture of different land use types that become the motivation of various behaviors at different times of day.

Another important issue is that the user behaviors are naturally context-aware, highly flexible, and sequential in time, and thus hard to model. There might be a potential behavior drifting that leads to a change in a user's profile. Also, it is difficult to have explicit supervisions like mapping or inferencing between any pair of different behaviors that could help build the new individual representations. For example, the user might have a vacation outside of town in a certain time, but the previous recurrent behavior may not happen until the user goes back to work. This requires a proper measurement to update the user profile based on both the observation of the user's current behavior and a prediction of the user's future behavior based on historical user behaviors.

The scalability and transfer learning issue is another critical issue to be addressed. Once implemented in a production system, distributed training strategy is often applied to address the large-scale dynamic data. The result of behavior learning is required to be consistent.

To achieve this, we propose a unified algorithmic framework for user modeling that is self-trained from the data without manual annotation. A desired predictive task is used to optimize the performance. The proposed system is expected to not only achieve accurate prediction but also enable comprehensive representation learning for users. The user profile learning framework can flexibly introduce semantic modeling and empower it by introducing representation learning of sequential user behavior data.

A user profile can be represented as the user's behavior records indicating what the user did during the history of the user's actions. The existing method to create a user profile is to fulfill a key-value pair to a dictionary based on a demographic feature or a user activity record. For example, an e-purchase profile for user i can be: {‘gender’:‘male’, ‘age’:30, ‘most frequent purchase item’:‘electronic’, . . . }. However, such mapping and modeling is very difficult to be optimally and quantitatively processed for characterizing the user due to the discrete value of data and lack of optimal formulation of problem.

User embedding has been well studied, e.g., in the recommendation system, to optimize the user-item rating prediction. It, however, has performance and scope limitations due to linearity in the modeling and it lacks a powerful sequential modeling capability like user behavior and context.

A user profile is a set of user's behaviors recorded by different objects such as location, time, item, etc. In order to give a quantitative analysis of objects, representation learning is applied to generate an “embedding” vector for different objects. An embedding is a mapping of a discrete-categorical-variable to a vector of continuous numbers. It can help compute the distance or similarity between different objects such as two locations, two users, or even two timestamp. Normally, embedding can be trained in a data-driven framework to enrich the semantic meaning of objects.

Regarding the representation learning method, a user profile can be generated as a sequence of user behavior records ordered by timestamps t through a sequence modeling method such as an attention-based framework. See, e.g., https://arxiv.org/pdf/1711.06632.pdf. A problem with this method, however, is that the output of the user profile is still a varied-length sequential data. Such a structure makes it difficult to compare among different users features of the user to support other downstream tasks such as user segmentation.

We have applied sequential modeling to convert sequential data into a fixed-length vector that represents the user profile. However, one critical issue of most sequential modeling method is the computation cost due to its non-parallelized nature, especially toward a large-scale dynamic dataset. Though there are some prior arts of user profile learning, the major difference is that we have proposed the algorithmic framework for sequential modeling that aims to generate a fixed-length user profile embedding considering both downstream performance and model scalability. With user profile learning, the system is able to better understand the user's context and behavior, and provide and improve the contextual and personal experience, such as recommendation, prediction, user segmentation, and the like.

All users are different, as characterized by user modeling, which addresses the need for personalized service. The user profile is multi-faceted, including preference, interest, habit, music, goods, readings, mobility, shopping, and the like. It is highly expected but a challenge to have holistic user modeling to address the multi-faceted behavior.

We assume that user behavior is driven and transformed by personal characteristics that are hidden but exist. We are able to qualitatively perceive the behavior, but not in a computation manner. User behavior generates the observable data that can be collected, such as driving trajectory, shopping log, and the like. If we are able to have a good trainable framework for transforming user behaviors, we can formulate user modeling by estimating the transformation.

In the present invention, we introduce a modified attention based framework for a first transformation (transform 1) and modified sequence based long short term memory (LSTM) network for a second transformation (transform 2) that enables deep learning of user characteristics represented by embedding. From the collected data as observation, we can estimate the modeling to minimize the loss between the target and the prediction. In the data collection, we can take any data as a target, and leverage previous history as an input, and thus the framework is supervised, but no annotation or labeling is required, with the potential to be self-learning all from the data.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 illustrates a flow chart according to an exemplary embodiment of the present invention.

FIG. 2 illustrates a general user profile learning system according to the present invention.

FIG. 3 illustrates a standard long short term memory (LSTM) network trained under a downstream prediction task according to the present invention.

FIG. 4 illustrates an exemplary spread of data points for users i, j and k, in which user j is the most similar to user i and user k is the least similar to user i.

FIG. 5 illustrates the raw activity log for users i, j and k corresponding to FIG. 4.

FIG. 6 illustrates an exemplary embodiment of a method according to the present invention.

FIG. 7 illustrates a schematic block diagram of a system according to an exemplary embodiment of the present invention.

### DETAILED DESCRIPTION OF THE DRAWINGS

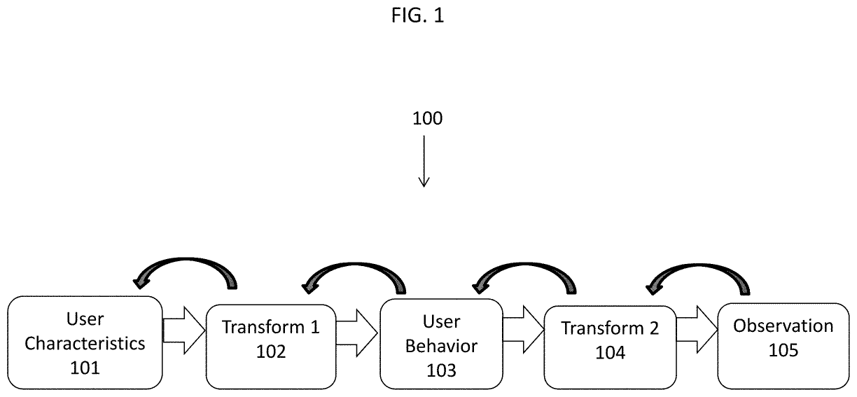

FIG. 1 illustrates a flow chart according to an exemplary embodiment of the present invention. As illustrated in FIG. 1, the process 100 includes obtaining user characteristics in step 101, transforming the user characteristics in step 102 using an attention based framework and producing a user behavior record in step 103. In step 104, the user behavior record is transformed using a modified sequence based LSTM network, which produces an observation matrix in step 105. LSTM networks are artificial recurrent neural network (RNN) architectures used in the field of deep learning. This enables deep learning of user characteristics represented by embedding. From the collected data as observation, we can estimate the modeling to minimize the loss between the target and the prediction, where the loss function is defined. In the data collection, we can take any data as a target, and leverage previous history as an input, and thus the framework is supervised, but no annotation or labeling is required, with the potential to be self-learning all from the data.

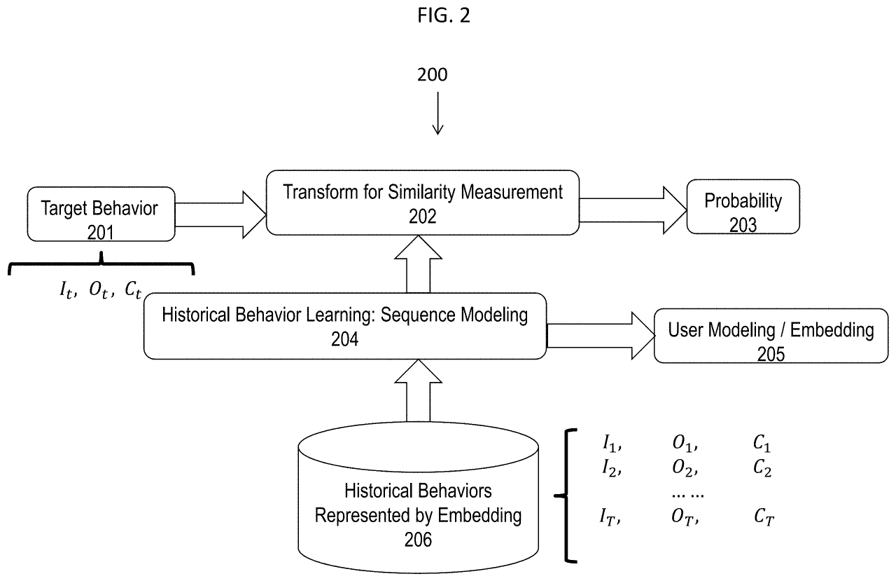

FIG. 2 illustrates a general user profile learning system according to the present invention. According to this system, the algorithm takes one behavior record as a target 201 and historic behaviors 206 are input to the sequence modeling 204. The historical data is used to train the model. From this information, a transform for similarity measurement is performed 202 and a probability between the prediction and the target is output 203, wherein the loss function is defined as the probability between the prediction and the target as the ground truth, such as the cross entropy. A unique aspect of this system is that the algorithm is organized as supervised, but there is no manual annotation or labeling needed. After the sequence modeling is performed based on the historical behavior learning 204, the user modeling/embedding 205 is performed.

According to the proposed algorithm, user behaviors are input and the output is a prediction of the possibility of a target behavior occurring and a user profile inference. The algorithm includes semantic modeling, in which objects (e.g., user interaction I, content O, and context C) are transformed into sematic space. A transform is performed to provide a similarity measure between historical behaviors and the target behavior. The possible behaviors are ranked and the most possible behavior, having the highest similarity against the historical behaviors, is selected as the target behavior. According to the algorithm, the user modeling is based on historical behavior learning, and an evaluation is performed using an N-best match (exact match: 1-best). The algorithm according to the present invention provides rich semantic modeling using discriminative training with a small similarity model and an online learning capability.

We introduce the transfer learning method to leverage previous leanings from a pre-trained model and avoid starting from scratch for the user profile learning. The pre-trained model is based on a behavior learning model that is supervised and trained based on the loss defined by a prediction task, e.g., destination recommendation. User behavior is defined as taking certain action on certain content at the given context. All user interaction I, content O, and context C are modeled to construct the feature modeling layer consisting of the raw input. Besides the final prediction result, the embedding of objects are trained to have the following matrix:

E({I})=[[I_{1,1}, I_{1,2}, . . . , I_{1,H}], . . . , [I_{Q,1}, I_{Q,2}, . . . , I_{Q,H}]]

E({O})=[[O_{1,1}, O_{1,2}, . . . , O_{1,H}], . . . , [O_{K,1}, O_{K,2}, . . . , O_{K,H}]]

E({C})=[[C_{1,1}, C_{1,2}, . . . , C_{1,H}], . . . , [C_{P,1}, C_{P,2}, . . . , C_{P,H}]]

r=concatenateₐₓᵢₛ₌₁(E(I_{q}), E(Oₖ), E(Cₚ))×w+b

where H is the pre-defined feature size of embedding vector, Q, K, P is the size of user interaction, content, and context, respectively, w and b are also the pre-train parameters, r represents one behavior record based on user interaction I_{q}, content Oₖ, and context Cₚ.

In practice, the pre-trained model can help to transfer the knowledge learned previous and greatly decrease the computation time. The training can be done offline then deploy the learned embedding as features to be fed into proposed user profile learning framework.

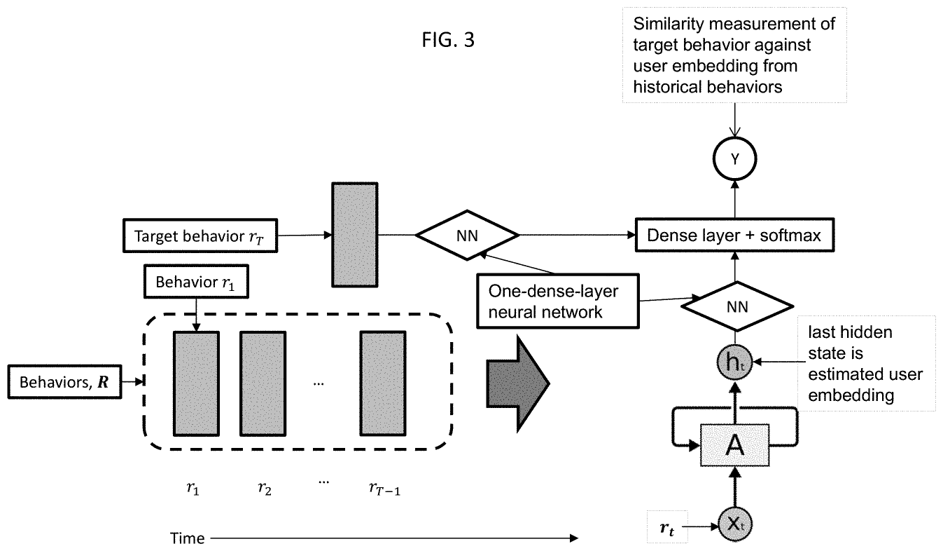

FIG. 3 illustrates a standard long short term memory (LSTM) network trained under a downstream prediction task according to the present invention. Given that a user's behaviors consist of a sequence of user behavior records ordered by timestamps, assume the user has T numbers of behavior records, we concatenate all behavior records r along axis t to generate an (H, T)-size matrix R=(r₁r₂ . . . r_{T})ₜ, where H and T may be, for example, 30 and 128 dimensions, respectively. Instead of using user behaviors matrix R to represent the user, we applied a sequence modeling to convert the varied-length matrix to a fixed-length embedding vector. Here we implemented a standard long short term memory (LSTM) network trained under a downstream prediction task as illustrated in FIG. 3, in which element A represents an LSTM unit.

As illustrated in FIG. 3, the target behavior FT and the behaviors matrix R are input to the sequence model. In FIG. 3, xₜ represents the input vector of the LSTM unit, hₜ represents the output vector of the ASTM unit, and Y represents the output including the fixed-length embedding vector.

As one user's behavior might drift along time due to either a non-recurrent event such as a vacation or periodical event such as weekday/weekend routines, we propose a recursive representation of user embedding through considering the delay of the past behaviors and the observed current behaviors. Let Uₜ the user embedding calculated based on user historical behaviors R_{t:t}_{₀}_{˜t}_{₀}^{+Δt} starting from timestamp t₀ to t. The predicted user embedding at time t+Δt can be calculated as follows:

U*_{t+Δt}=α*U*ₜ+(1−α)*U_{t+Δt}

where U*ₜ is prediction value and U_{t+Δt} is the observation value.

We explored the deployment of the proposed model on a trip pattern prediction task that predicts which location a user will visit at a certain time given his/her trip history in an experiment. The dataset includes user location tracking including driving. Raw features of the experiment include, for example, <user ID, location_gps_grid_ID, timestamp), 100 users, 1578 locations through 200 m×200 m grid by map segmentation, over a 6-month period. For the task, we assume a user interaction for user u is the following:

Iᵤ={(visit location i₀ at time t₀), . . . , (visit location i_{T} at time t_{T})}, where we use the first k of Iᵤ to predict the k+1-th visit in the train set, where data contains both location i and timestamp t information for the visit, and use the first n−1 visit to predict the last one in the test set. We applied top 1-best matching accuracy that is widely used in recommendation systems to measure the performance. Meanwhile, parameter number and response time were reported to indicate the scalability. We also evaluated our model in the online learning case for distributed training purposes.

We benchmarked the model performance based on different training scenarios (online or offline) and whether transfer learning is enabled. The prediction accuracy and response time are both evaluated on the same test set across all indexed models. The result is shown in the following Table 1.

TABLE 1

| | Online | Transfer | | | Prediction accuracy | Trainable | Response time |
|---|---|---|---|---|---|---|---|
| Index | Learning | Learning | Training Data | Model | (Top 1 Matching) | Parameters | (second/100 users) |
| 1 | N | N | 6-month data | Baseline | 0.81 | 324,590 | 2.445 |
| 2 | N | Y | 6-month data | Pre-trained Baseline + | 0.83 | 456,174 | 0.309 |
| | | | | LSTM | | | |
| 3 | Y | Y | First 5-month data | Pre-trained Baseline + | 0.85 | 456,174 | 0.309 |
| | | | for offline training, | LSTM | | | |
| | | | last 1-month data | | | | |
| | | | for online training | | | | |
| 4 | N | Y | Last 1-month data | Pre-trained Baseline + | 0.76 | 456,174 | 0.309 |
| | | | | LSTM | | | |

As illustrated in Table 1, when both online learning and transfer learning are enabled, the result of index 3 shows that our proposed algorithm improves the prediction and greatly decreases the response time.

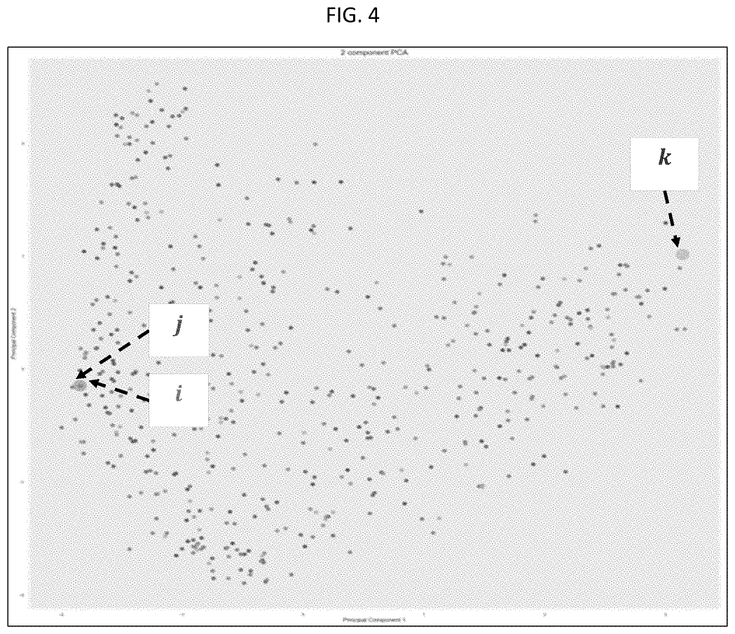

FIG. 4 illustrates an exemplary spread of data points for users i, j and k, in which user j is the most similar to user i and user k is the least similar to user i. We explored the learned embedding of 100 users. First, we computed the pairwise similarity d among users through Euclidean distance measurement. Second, we visualized the 100 embedding vectors through a dimension reduction by principle component analysis. We chose the ith user as an example for illustration. For user i, we found the user j that represents the most similar user and user k that represents the most different user based on the following equation:

$$j = {argmin}_{j} ( {d}_{i j} ) ; k = {argmax}_{k} ( {d}_{i k} ) ,$$

where the data points of user i, j, and k are shown in FIG. 4. The distribution of points is consistent with the distance measurement that user i and user j are mostly overlapping each other, while user k is located in a remote area.

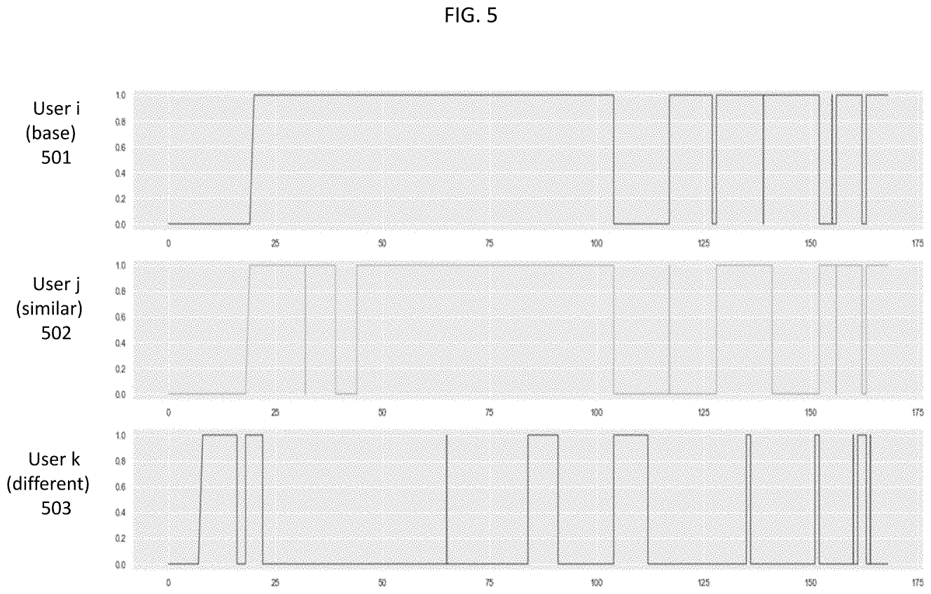

FIG. 5 illustrates the raw activity log for users i, j and k corresponding to FIG. 4. The x-axis represents the trip timestamp while the y-axis shows the visited locations which have been re-indexed to 0 and 1 for illustration. Once the user changed the location, the index shifted from the current one to another one. This shows that the user embedding is consistent with the observation of user similarity.

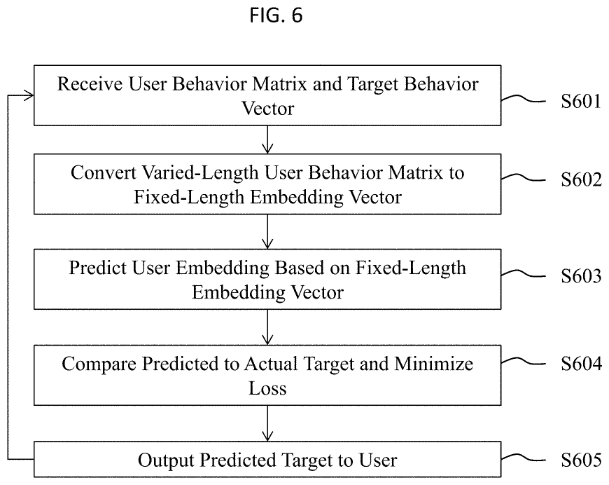

FIG. 6 illustrates an exemplary embodiment of a method according to the present invention. In step S601, a variable-length user behavior matrix and a target behavior vector are received. In step S602, the variable-length user behavior matrix is converted into a fixed-length embedding vector. The user embedding is predicted in step S603 based on the fixed-length embedding vector, and in step S604 the target behavior is compared to the actual behavior to determine the loss (error) in the prediction. The target behavior may then be outputted to the user and/or may be recursively determined again in step S605.

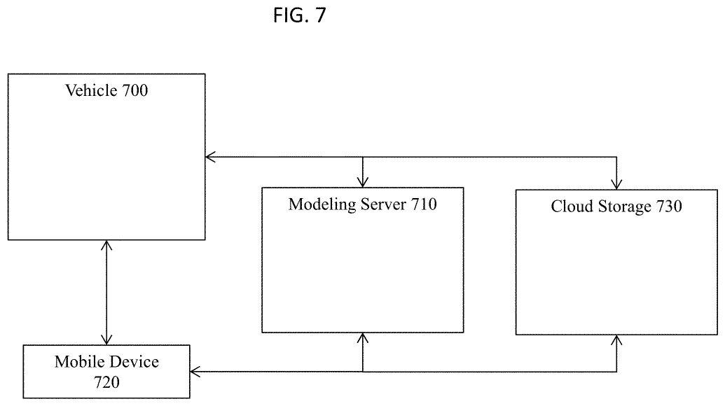

FIG. 7 illustrates a schematic block diagram of a system according to an exemplary embodiment of the present invention. The system may include, for example, a vehicle 700, a modeling server 710, a mobile device 720, and cloud storage 730. Each of these devices has its own processor and memory and a communication interface(s), wherein the processors are specifically programmed to perform the functions described herein. Telemetry data and the like may be received from the vehicle 700 and may be received from the mobile device 720. The mobile device 720 may be a smart phone, tablet computer or the like. Communication between the modeling server and the vehicle/mobile device may occur via cellular network, WiFi, Bluetooth, or the like. Data gathered from the vehicle 700 and the mobile device 720 may be transmitted to the modeling server 710 or transmitted directly to cloud storage 730.

In another exemplary embodiment of the present invention, a non-transitory computer-readable medium is encoded with a computer program that performs the above-described method. Common forms of non-transitory computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, an EPROM, a FLASH-EPROM, any other memory chip or cartridge, or any other medium from which a computer can read.

The present invention provides a number of significant advantages over conventional systems and methods. In particular, the present invention provides a unified algorithmic framework for user modeling based on user behavior that is able to extend to become feature toward different services. The user can be flexibly trained for different tasks driven by user behavior, e.g., predicted destination driven by mobility behavior, recommended feature by app usage behavior, etc. The semantics are enriched for users, which allows computation among users, e.g., user segmentation, user similarity based recommendation, and predictive modeling.

Also, the system and method according to the present invention has low complexity that improves the service online computation due to compact user modeling and improves the user experience by leveraging personal context to have better predicted performance. The present invention also provides a solution to data sparsity. Additionally, the present invention enables transfer learning and online learning. The pre-trained model can help to transfer the knowledge learned previously and greatly decrease the computation time. Meanwhile, the online learning enables the distributed training to deal with computation scalability to address the large-scale dataset in real-world applications.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for performing deep user modeling, comprising:
determining user behavior vectors that represent historical user behaviors of a user;
determining a variable-length user behavior matrix based on a concatenation of the user behavior vectors;
converting the variable-length user behavior matrix into a fixed-length embedding vector via a long short term memory network; and
outputting the fixed-length embedding vector to the user as a predicted target behavior.

2. The method according to claim 1, further comprising:
updating the variable-length user behavior matrix based on the predicted target behavior.

3. The method according to claim 1, further comprising:
guiding the user to a predicted destination in a vehicle based on the predicted target behavior.

4. The method according to claim 1, wherein the fixed-length embedding vector represents a user profile.

5. The method according to claim 1, further comprising:
determining an error between the predicted target behavior and an actual user behavior.

6. The method according to claim 5, further comprising:
updating the user behavior vectors based on the error.

7. A method for modeling behavior of a user, comprising:
receiving user characteristics data of a user;
transforming the user characteristics data into user behavior data based on an attention based framework;
transforming the user behavior data into a predicted target of user behavior based on a long short term memory processing of the user behavior data; and
outputting the predicted target to a mobile device or vehicle of the user.

8. The method according to claim 7, further comprising:
determining an error between the predicted target and an actual user behavior.

9. The method according to claim 8, further comprising:
updating the user behavior data based on the error.

10. A non-transitory computer-readable medium storing a program that, when executed by a processor, causes the processor to perform a method comprising:
determining user behavior vectors that represent historical user behaviors of a user;
determining a variable-length user behavior matrix based on a concatenation of the user behavior vectors;
converting the variable-length user behavior matrix into a fixed-length embedding vector via a long short term memory network; and
outputting the fixed-length embedding vector to the user as a predicted target behavior.

11. The non-transitory computer-readable medium according to claim 10, further comprising:
updating the variable-length user behavior matrix based on the predicted target behavior.

12. The non-transitory computer-readable medium according to claim 10, further comprising:
guiding the user to a predicted destination in a vehicle based on the predicted target behavior.

13. The non-transitory computer-readable medium according to claim 10, wherein the fixed-length embedding vector represents a user profile.

14. The non-transitory computer-readable medium according to claim 10, further comprising:
determining an error between the predicted target behavior and an actual user behavior.

15. The non-transitory computer-readable medium according to claim 14, further comprising:
updating the user behavior vectors based on the error.
